(19) United States
(12) Patent Application Publication
(10) Pub. No.: US 2024/0420430 A1
(43) Pub. Date: Dec. 19, 2024

(54) LOCATION BASED IMMERSIVE CONTENT SYSTEM

(71) Applicant: Lucasfilm Entertainment Company Ltd. LLC, San Francisco, CA (US)

(72) Inventors: Michael Koperwas, San Francisco, CA (US); Earle M. Alexander, IV, San Francisco, CA (US)

(73) Assignee: Lucasfilm Entertainment Company Ltd. LLC, San Francisco, CA (US)

(21) Appl. No.: 18/743,530

(22) Filed: Jun. 14, 2024

Related U.S. Application Data
(60) Provisional application No. 63/521,440, filed on Jun. 16, 2023.

(51) Int. Cl. G06T 19/00; G01S 19/42

(52) U.S. Cl. CPC G06T 19/006; G01S 19/42

(57) ABSTRACT

A computer-implemented method comprising: capturing, with a mobile device comprising a camera and a display, a first image of a physical environment and first set of telemetry data corresponding with the first image, wherein the first set of telemetry data comprises GPS location data along with orientation data; transmitting, to a server system via a wireless communication channel, the first set of telemetry data; determining, with the server system, a precise location and orientation of the mobile device in the physical environment based on the first set of telemetry data received from the mobile device and on information accessed from multiple sources of data including one or more of a street map database, visual positioning system (VPS) data, and image anchors; rendering an image of virtual content based at least in part on the first set of telemetry data for the mobile device, wherein the rendered image of virtual content is over rendered such that it represents a larger area in the virtual world than the first image represents in the physical environment; transmitting the rendered image and the first set of telemetry data back to the mobile device via the wireless communication channel; capturing, with the mobile device, a second image and a second set of telemetry data, wherein the second set of telemetry data comprises gps location data along with orientation data; compositing, at the mobile device, a subset of the rendered image with the second image, wherein the subset of the rendered image is determined based changes between the first and second sets of telemetry data; and displaying the composited image on the display of the mobile device such that the virtual content appears in the physical environment.

### CROSS-REFERENCES TO RELATED APPLICATIONS

This application claims priority to U.S. Provisional Patent Application No. 63/521,440, filed Jun. 16, 2023, the disclosure of which is hereby incorporated by reference in its entirety for all purposes.

### BACKGROUND OF THE INVENTION

Modern computing systems have enabled the development of augmented reality, which provides an interactive experience that combines the real world and computer-generated three-dimensional (3D) content. The content can span multiple different sensory modalities, including visual and auditory senses. In essence, augmented reality can provide a live view of a real-world environment that is augmented by computer-generated graphics, video and sound. In contrast to virtual reality, which replaces the real-world environment with a simulated one, augmented reality elements are typically displayed in real time in conjunction with elements of the real-world environment.

Some companies have used augmented reality as a form of entertainment. For example, some companies allow for an augmented reality treasure hunt in which virtual objects or treasures are hidden in the real world. The objects can be located at specific GPS coordinates in the real world and a treasure hunter (i.e., player) can use a mobile device, such as a smart phone with global positioning satellite (GPS) functionality and a display, to search for clues and solve puzzles that can ultimately lead the player to the treasure. In another example, an augmented reality game allows a player to locate and interact with objects that are in proximity to the player's real-world location. The objects can be elements that are part of a continuous overall narrative that the player can participate in and explore. As still another example, one augmented reality game allows players with GPS-equipped mobile devices to locate, capture, train and battle virtual characters which appear as if they are in the player's real-world location.

While these forms of augmented reality can provide enjoyable entertainment for many different players or users, each of the systems described above have limitations that limit the scope of, and immersive nature of, the experience provided. Accordingly, improvements to various augmented reality experiences are continuously being sought.

### BRIEF SUMMARY OF THE INVENTION

Embodiments disclosed herein pertain to methods and a system for providing for an augmented reality experience within a physical, real-world environment by supplementing the physical environment with persistent virtual content that can be accessed by multiple different users (sometimes referred to herein as “participants”) at any given time. The augmented real-world environment can be at pre-determined locations and set scale, and embodiments allow each participant to travel to locations within the virtual environment and interact with location-specific virtual content (e.g., virtual characters, virtual objects and/or other virtual assets) that provides experiences specific to the different locations. Additionally, embodiments can track participants based on their location and enable the virtual content to react to participants as a participant traverses through the virtual world.

In accordance with some embodiments, a computer-implemented method of creating an augmented reality experience is provided where the method includes: capturing, with a mobile device comprising a camera and a display, a first image of a physical environment along with location data and orientation data corresponding to the first image; transmitting, to a server system via a wireless communication channel, the location and orientation data; determining, with the server system, a precise location and orientation of the mobile device in the physical environment based on the location and orientation data received from the mobile device and on information accessed from multiple sources of data including one or more of a street map database, visual positioning system (VPS) data, and image anchors; rendering, with the server system, an image of virtual content based on the precise location of the mobile device determined by the server system; transmitting the rendered image back to the mobile device via the wireless communication channel; compositing, at the mobile device, the rendered image with an image of the physical environment captured by the mobile device; and displaying the composited image on the display of the mobile device such that the virtual content appears in the physical environment.

In some embodiments, a method of creating an augmented reality experience includes: capturing, with a mobile device comprising a camera and a display, a first image of a physical environment and first set of telemetry data corresponding with the first image, wherein the first set of telemetry data comprises GPS location data along with orientation data; transmitting, to a server system via a wireless communication channel, the first set of telemetry data; determining, with the server system, a precise location and orientation of the mobile device in the physical environment based on the first set of telemetry data received from the mobile device and on information accessed from multiple sources of data including one or more of a street map database, visual positioning system (VPS) data, and image anchors; rendering an image of virtual content based at least in part on the first set of telemetry data for the mobile device, wherein the rendered image of virtual content is over rendered such that it represents a larger area in the virtual world than the first image represents in the physical environment; transmitting the rendered image and the first set of telemetry data back to the mobile device via the wireless communication channel; capturing, with the mobile device, a second image and a second set of telemetry data, wherein the second set of telemetry data comprises gps location data along with orientation data; compositing, at the mobile device, a subset of the rendered image with the second image, wherein the subset of the rendered image is determined based changes between the first and second sets of telemetry data; and displaying the composited image on the display of the mobile device such that the virtual content appears in the physical environment.

In some embodiments, a computer-implemented method of creating an augmented reality experience is provided where the method includes: capturing a first image of a physical environment and first set of telemetry data corresponding with the first image, wherein the first set of telemetry data comprises gps location data and orientation data; transmitting the first set of telemetry data to a server system via a wireless communication channel; receiving a rendered image of virtual content from the server system via the wireless communication channel, wherein the rendered image is generated based at least in part on the first set of telemetry data and wherein the rendered image of virtual content is over rendered such that it represents a larger area in the virtual world than the first image represents in the physical environment; capturing a second image of a physical environment and second set of telemetry data corresponding with the second image, wherein the second set of telemetry data comprises gps location data and orientation data; compositing, at the mobile device, a subset of the rendered image with the second image, wherein the subset of the rendered image is determined based changes between the first and second sets of telemetry data; and displaying the composited image on the display of the mobile device such that the virtual content appears in the physical environment.

In still other embodiments, methods disclosed herein include: receiving, from a mobile device comprising a camera and a display, a first set of telemetry data corresponding with a first image, wherein the first set of telemetry data comprises GPS location data along with orientation data; determining a precise location and orientation of the mobile device in the physical environment based on the first set of telemetry data received from the mobile device and on information accessed from multiple sources of data including one or more of a street map database, visual positioning system (VPS) data, and image anchors; rendering an image of virtual content based at least in part on the first set of telemetry data for the mobile device, wherein the rendered image of virtual content is over rendered such that it represents a larger area in the virtual world than the first image represents in the physical environment; and transmitting the rendered image and the first set of telemetry data back to the mobile device via the wireless communication channel.

In various implementations, methods disclosed herein can include one or more of the following steps or features. The orientation data can include roll, yaw and pitch data. The rendered image sent by the server system can include six channels of information including separate channels for red, green, blue, alpha, depth and shadow data. The six channels of information can be sent in every frame by splitting each frame into top and bottom portions and sending the RGB data in one of the top and bottom portions and sending the alpha, shadow and depth data in the other of the top and bottom portions. The six channels of information can be sent over two consecutive frames by repeatedly sending a first frame with the RGB data and, immediately following the first frame, sending a second frame with the alpha, shadow and depth data. The telemetry data can be sent by the mobile device to the server at a first frequency of between 30-120 Hz and the mobile device can also send camera settings data including data representing the field of view (FOV) and resolution of the camera and data indicating the focal length and f-stop of the lens that the first image was captured at.

To better understand the nature and advantages of the present invention, reference should be made to the following description and the accompanying figures. It is to be understood, however, that each of the figures is provided for the purpose of illustration only and is not intended as a definition of the limits of the scope of the present invention. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIG. 1 is simplified illustration of a physical world view of two participants at a specific real-world location while participating in an augmented reality experience created by an embodiment of a location-based immersive content system disclosed herein;

FIG. 2 is a simplified illustration of three-dimensional virtual characters and objects that inhabit the specific-real world location shown in FIG. 1;

FIG. 3 is a simplified illustration of the specific real-world location shown in FIG. 1 populated with the three-dimensional virtual characters and objects shown in FIG. 2 according to some embodiments disclosed;

FIG. 4A is a simplified illustration of a mobile device display (held by the left most participant in FIG. 3) with the portion of the scene depicted in FIG. 3 as seen by the mobile device presented on the display according to some embodiments;

FIG. 4B simplified illustration of a mobile device display (held by the right most participant in FIG. 3) with the portion of the scene depicted in FIG. 3 as seen by the mobile device presented on the display according to some embodiments;

FIG. 5 is a simplified block diagram of a location-based immersive content system according to some embodiments;

FIG. 6 is a simplified block diagram of a location-based immersive content system according to some embodiments;

FIG. 7 is a simplified flow chart depicting steps associated with a method according to some embodiments;

FIG. 8 is a simplified flow chart depicting steps associated with a method according to some embodiments; and

FIG. 9 is a simplified block diagram of an exemplary computer system, in which parts of various embodiments disclosed herein can be implemented.

### DETAILED DESCRIPTION OF THE INVENTION

Embodiments of the present invention are directed at a system, method, and techniques for a location-based immersive content system. The system can create a virtual reality world by populating the real world with virtual characters and virtual objects. The characters and objects can be populated by geolocation enabling the virtual characters and objects to “live” in the virtual world at locations which correspond to real world locations. Computer-generated content created by the location-based immersive content system can be persistent, that is always available or present, for any person participating in the system. In this manner, embodiments disclosed herein enable a focus on interactive “story living” instead of just providing a more linear, storytelling experience. As an illustration, in some embodiments, instead of having content that is generated based primarily on a timeline associated with a user (participant) first starting in the system, the virtual content can be present in the virtual reality world and available to be seen and/or interacted with by participants in the system at all times, much like animals at a zoo are always present in their display area or living quarters at the zoo.

The system allows multiple participants to simultaneously explore a virtual world and participate in one or more interactive storylines created by the system. Each storyline can include different virtual characters that reside at different real-world locations or that are associated with certain times or conditions within the real or virtual world. While in the virtual world, the participants can make meaningful choices that drive one or more storylines forward. The participants can also cross paths with each other and at times can be interacting with the same virtual character or object at the same time.

Virtual characters created by the system can be populated in the virtual world at specific locations corresponding to locations in the real world. The virtual characters can be aware of the environment in which they are present. The virtual characters can react to the presence of one or more participants that enter their environment and other participants in the environment can witness such reactions. As one example, a location-based immersive content system can populate a location in the real world with virtual content of a droid. When a first participant sees and walks up to the droid, the droid can face and start talking to the first participant relaying some information or message that is relevant to a story line that the location-based immersive content system has generated. A second participant standing to the side of the first participant can witness the droid talking to the first participant, and if the second participant is close enough, hear parts or all of the conversation. It is also possible that each participant sees and hears their own version of the conversation.

The virtual reality worlds that can be created by systems disclosed herein are sometimes referred to herein as an “augmented-reality setting” (or “AR setting” for short) since the created worlds or settings include a real-world location supplemented with virtual reality content. In some embodiments an AR setting can have physical boundaries within the real world that align with boundaries of the corresponding virtual world such that virtual reality content generated by embodiments can be kept within (limited to) the physical-world boundaries. For example, in some embodiments an AR setting can be defined by a series of fences, water features (e.g., rivers, lakes), roads or other physical structures in the physical world that create a boundary for the AR setting. In other embodiments, the AR setting can be bounded by geolocated features, such as by city, county or state lines. In still other embodiments, the AR setting can be global in scale and include essentially the entire real world without any physical boundaries.

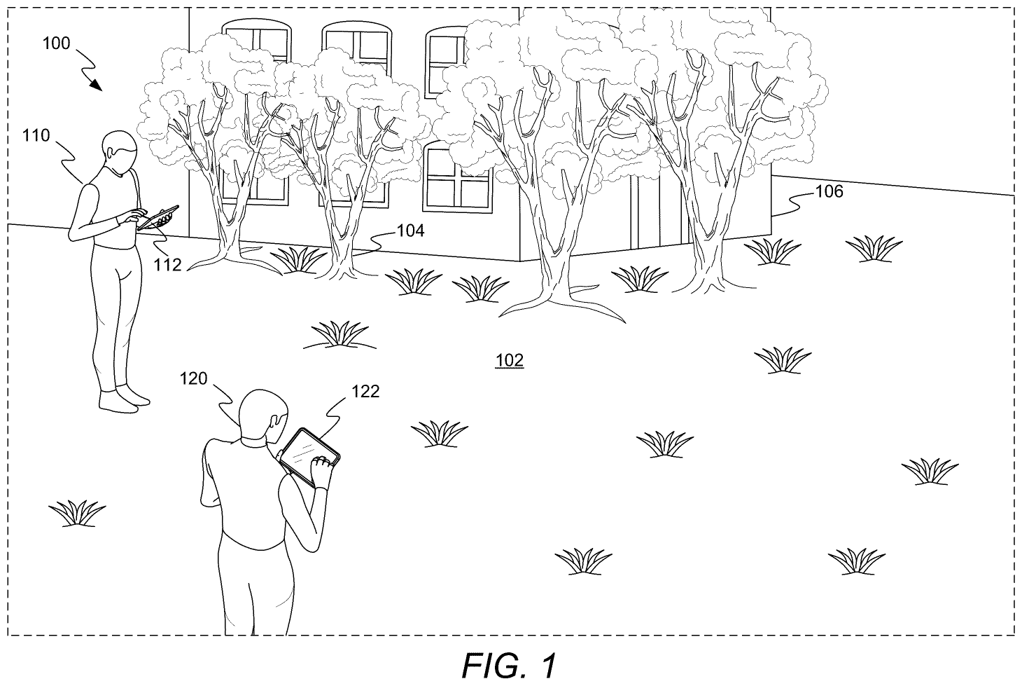

In order to better appreciate and understand embodiments disclosed herein, an example of an augmented reality experience that can be provided by embodiments disclosed herein is presented in conjunction with FIGS. 1-3 and FIGS. 4A and 4B. Reference is first made to FIG. 1, which is a simplified illustration of two different people (participants) in an augmented reality experience created by an embodiment. As shown in FIG. 1, first and second participants 110, 120 are standing in a location 100 within a larger area of the real physical world (i.e., an AR setting) in which virtual world content can be added by a location-based immersive content system 140 (sometimes referred to herein as “content creation system 140” for short). Location 100 includes an open grassy area 102, several trees 104 and a building 106, all of which are real physical features and objects. It is to be understood that features and objects shown in location 100 are for explanatory purposes only and other locations within in the background AR park. Location-based immersive content system 140 can be located remotely and can be implemented by a server system, such as a cloud-based computing service, as discussed in more detail below.

Participant 110 is holding a mobile device 112 and participant 120 is holding a mobile device 122. Each mobile device includes a wireless communication system and multiple location and orientation tracking sensors that enable the device to wirelessly communicate precise location and motion information to a server. Each mobile device 112, 122 also includes a camera and an electronic display that enables the device to capture the setting within location 100 and present the captured setting on the display for the respective participants 112, 122 to view. Examples of suitable mobile devices include, but are not limited to, smart phones, tablet computers, augmented reality and virtual reality goggles and the like.

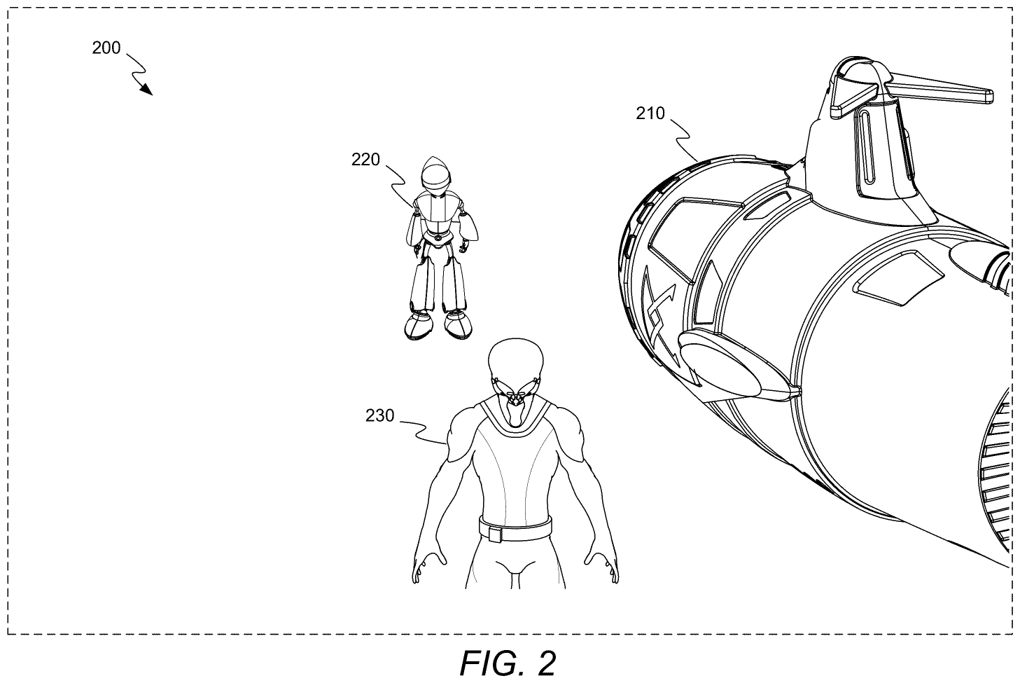

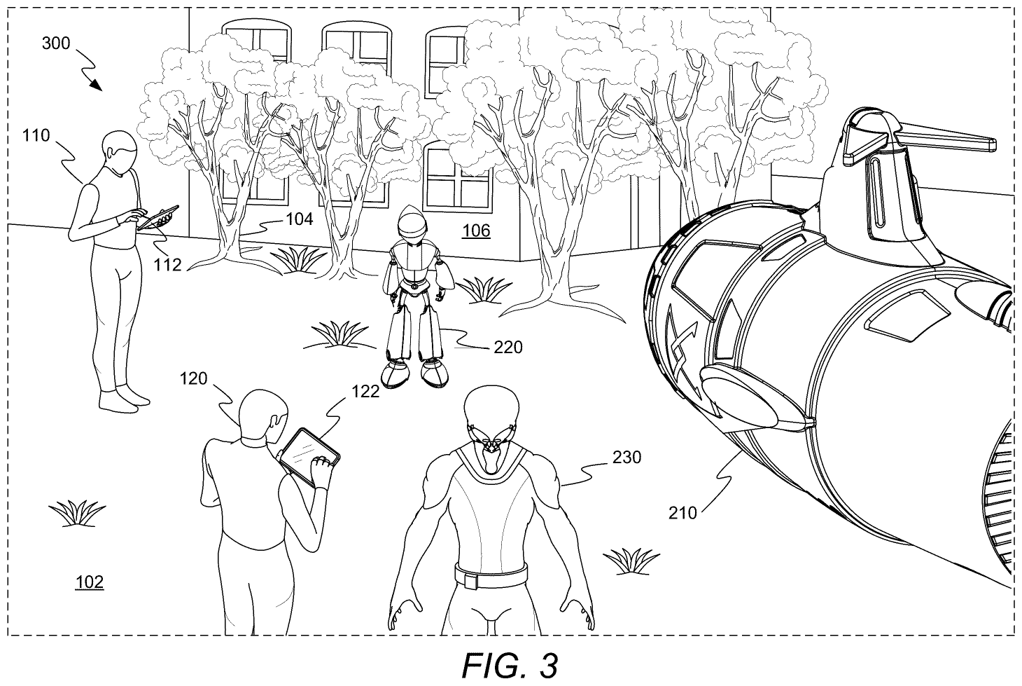

As shown in FIG. 1, each participant 110, 120 has positioned his respective mobile device 112, 122 towards an empty grassy area 102. The mobile devices can wirelessly send location and orientation tracking information to content creation system 140. As used herein, location data (sometimes referred to as position data) refers to data that locates a location or position, such as can be indicated by GPS coordinates, of the mobile device, while orientation data refers to data that indicates the direction the camera and display of the mobile device are facing at a given location (e.g., up, down, north, south, tilted sideways, etc.). The content system can then use the location and orientation information in creating virtual content that can be added to virtual representations of location 100 that are displayed on each mobile device creating an augmented reality experience for the participants. For example, FIG. 2 is a simplified illustration of virtual reality content 200 including a spaceship 210, a pit droid 220 and an alien creature 230. FIG. 3 depicts a scene 300 a story of the virtual world that includes virtual content 200 shown in FIG. 2 overlaid into location 100. Scene 300 represents the positions of virtual content 200 within the physical world at the same specific point in time illustrated in both FIGS. 1 and 2.

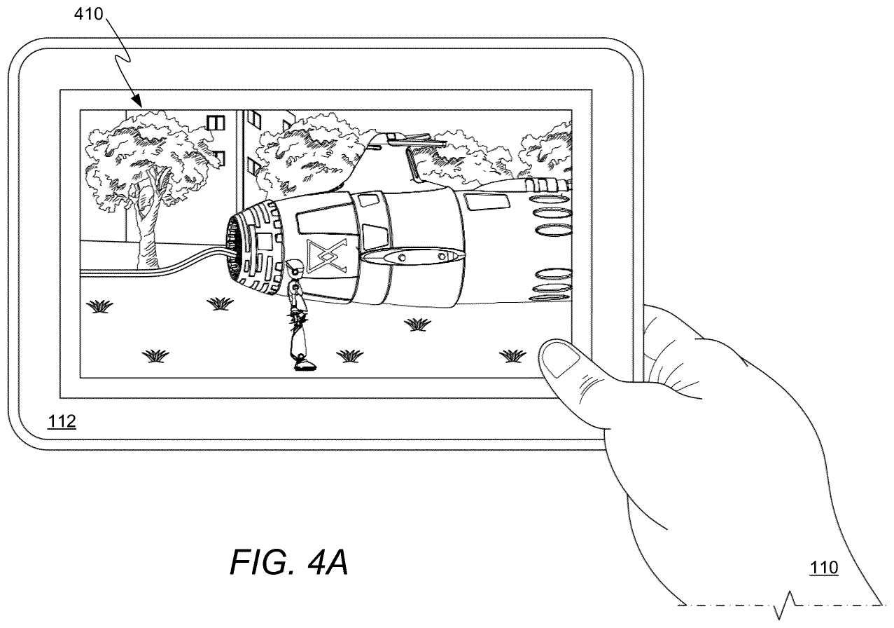

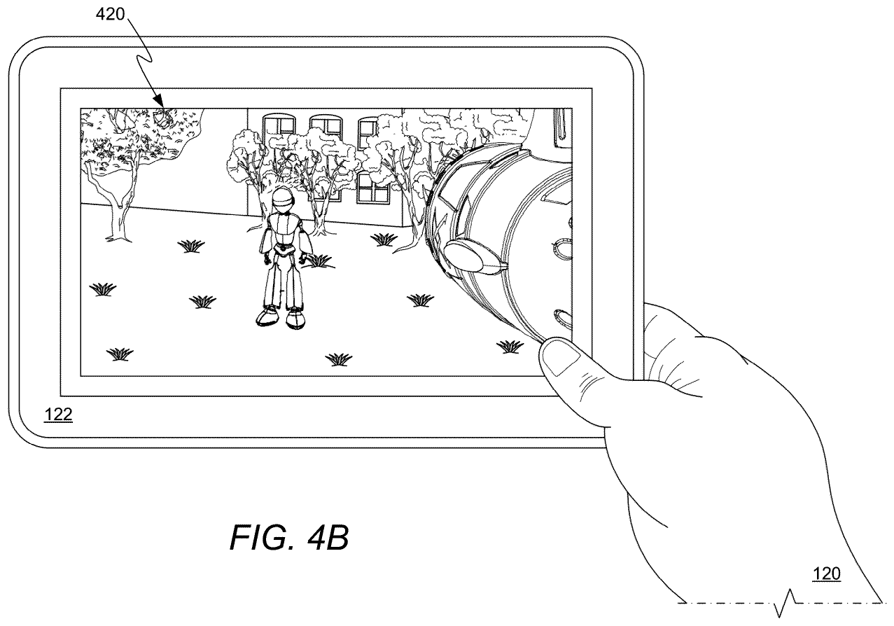

Referring now to FIGS. 4A and 4B, content creation system 140 can generate and render portions of virtual content 200 from the perspective of each of the participants 110, 120 and wirelessly send the rendered content to each participant. In this manner, a first view 410 of content 200 can be depicted on mobile device 112 as viewed from the perspective of participant 110 (FIG. 4A) while a second view 420 of content 200 can be depicted on mobile device 122 as viewed from the perspective of participant 120 (FIG. 4B). As evident from a review of FIGS. 4A and 4B, each of the mobile devices 112, 122 is displaying the same content from scene 300 generated based on the same point in real time, but from different perspectives. Thus, each of participants 110, 120 can be part of the same story, experiencing the story at the same time. It can be noted that while scene 300 includes alien creature 230, the creature is not “seen” by either of participants 110, 120 at the specific point in time reflected by FIGS. 4A and 4B because of the position of creature 230 as compared to the position and orientation of the participants.

### Immersive Content Systems

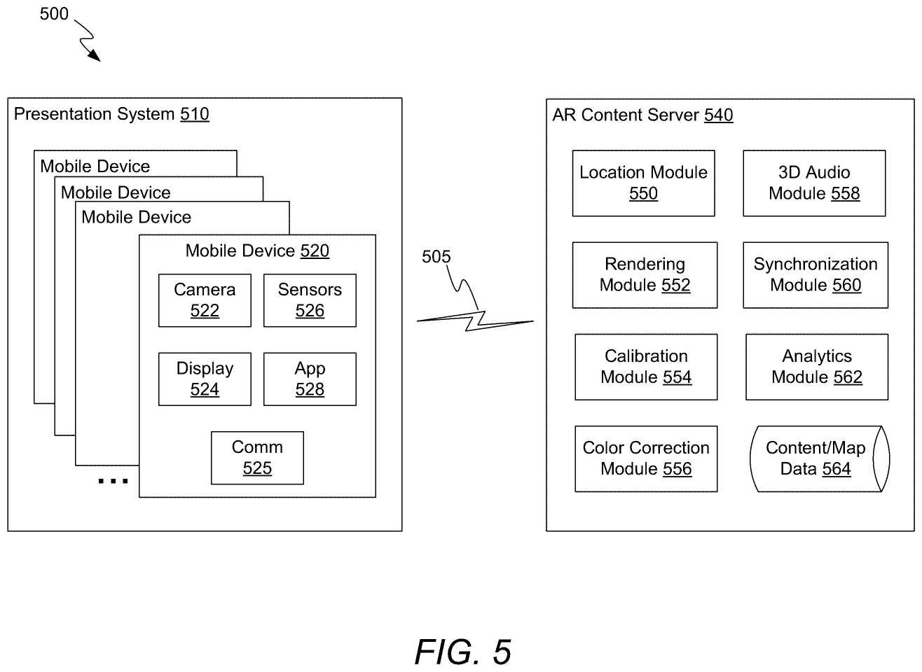

Reference is now made to FIG. 5, which is a simplified block diagram of a representative location-based immersive content system 500 (also referred to as the immersive content system) according to some embodiments. It should be appreciated that there can be additional components in system 500 that are not specifically depicted in FIG. 5 for case of illustration, and some of these additional system components and/or functionality they provide are referenced below.

As depicted in FIG. 5, immersive content system 500 includes a presentation system 510 and a location-based immersive content server 540 (sometimes referred to herein as an “immersive content server” for short). Presentation system 510 can be or include one or more mobile devices 520, such as smartphones, tablet devices, virtual reality (“VR”) goggles, augmented reality (“AR”) glasses, smartwatches, spatial computing devices, and/or any other device usable for displaying images of an item of content. Each mobile device 520 can be representative of the mobile devices 112, 122 discussed above.

Each mobile device includes one or more physical cameras 522, a display 524, a communication module 525, a sensor module 526 and a processor and computer-readable memory (not shown) that cooperate to execute program code stored in the computer-readable memory to implement an immersive software application program or “app” 528. When executing on mobile device 520, app 528 cooperates with the other components of mobile device 520 to capture, with one or more outward facing cameras of the cameras 522, a video stream (i.e., a continuous series of images) the environment the mobile device is positioned within and display the captured video stream on display 524 of the mobile device. In this manner, a participant can hold mobile device 520 in front of the participant and use the display of the mobile device as a “window” through which to view the physical environment that surrounds them. As the user pans mobile device 520 around the physical environment, display 524 can depict a view of the environment as captured by the camera. In many cases, the view of the physical environment should appear unchanged in terms of color, scale, and lighting when the mobile device 104 is removed from the user's field of view.

When app 528 is executing on the mobile device, telemetry information and other data related to frames in a video stream captured by cameras 522 can be sent to the immersive content server at a known frequency rate which can render virtual content that is sent back to the mobile device. In some embodiments, the telemetry data is sent at a set frequency rate in the range of 30-120 Hz and some implementations the known frequency rate is 60 Hz. App 528 can then composite the virtual content with the video stream as discussed below. In this manner, the user (participant) can view the virtual content within the real-world physical environment visible within the field of view of the mobile device camera. In some embodiments, “app” 528 can include a user interface for navigating and/or interacting with the virtual objects/characters of a virtual environment. The “app” 528 can additionally include status information indicating the location and/or the quality of the network connection of the mobile device.

Cameras 522 can include one or more outward facing cameras that capture high resolution images of the real-world physical environment in which mobile device 520 is positioned. The captured images can then be used by app 528 as background images of the real, physical environment on which rendered virtual content (e.g., one or more virtual characters or virtual objects) generated by immersive content server 540 is integrated and/or overlayed onto by app 528. For example, app 528 can generate a composited image onto display 524 as seen by a participant where the image includes a physical environment of the mobile device as captured by cameras 522 and first and second virtual objects rendered by immersive content system 540. Depth information for the first and second virtual objects generated by the immersive content system 540 enables app 528 to place the virtual objects within the composited image at specific distances from the participant. Thus, as an example, the composite image can be generated such that the first virtual object appears to be in front of an actual tree in the physical environment, and a second virtual object appears to be partially blocked/occluded by an actual bridge in the physical environment.

In some embodiments, the images of the virtual content can be pre-generated or rendered in real-time by a rendering module (discussed below). As used herein, the term “real-time” can include real-time or near real-time computing such that results are displayed to the user at interactive frame rates. In some embodiments, “real-time” can include displaying a composite image on the screen of the mobile device within 5 msec, 10 msec, 20 msec, 50 msec, or about 100 msec of a time at which the corresponding image was captured by the camera of the mobile device.

In addition to one or more cameras that face outward away from a user of mobile device 520, cameras 522 can also include one or more cameras or other sensors aligned towards the face of the user (participant) to track the orientation of the participant's eyes or other facial features over time. The tracked information can be communicated to immersive content server 540 and used to determine the specific location or specific objects or images at which the participant is looking at, which in turn can be used by server 540 in deciding on how to render virtual content that can be communicated to and displayed on display 524.

Display 524 can include an electronic display screen, such as an LED screen, an LCD screen, and/or the like as well as associated control circuitry for the display. Additionally, in some embodiments display 524 can include two or more displays that cooperate under the control of app 528 to depict scenes in the virtual world. The type and size of a given display 524 (or displays plural) can vary greatly depending on the type of mobile device 520 the display is incorporated into. For example, a display 524 that is part of a tablet computer can be significantly larger than the combined pair of displays 524 incorporated into augmented reality googles.

Communication module 525 allows mobile device 520 to communicate with immersive content server 540. In one embodiment, communication module 525 can employ a low latency communications protocol to communicate with immersive content server 540, such as an LTE, 4G or 5G cellular network. In one embodiment, the communications between the mobile device and the immersive content server can include the synchronization information, analytical information, telemetry information (e.g., location/position data along with orientation data) from sensor module 526, gaze information for a user's eyes, and settings information, physical environment information (e.g., weather conditions, lighting conditions).

In some embodiments, sensor module 526 can include one or more of a global positioning satellite chip, an accelerometer, a gyroscope, a proximity sensor, a digital compass, among others and the telemetry information can include position information (e.g., GPS position) and orientation data (e.g., yaw, pitch, and roll data). The telemetry information indicates location and orientation information as to where the mobile device is within the physical world at a precise moment in time. In some embodiments, the telemetry information can be provided by a software developer kit or similar feature of mobile device 620, such as the ARKit available for Apple IOS devices or the ARCore available for android devices. Once collected, the telemetry information can be wirelessly communicated to the immersive content server from the mobile device over communications link 505 at an appropriate frequency rate, such as 60 Hz.

In some embodiments, the physical environment information can be captured in RGB images as part of an environment sphere that can be used by immersive content server 540 to improve lighting of rendered virtual content. The information can be communicated/updated by the mobile device to the immersive content server based on movement thresholds of the user/mobile device. In some embodiments, the physical environment information can include selected anchor data. The anchor data can include geographic location data, anchor images, a plane anchor, etc. Basically, an anchor can be known objects or other items in the scene that immersive content server 540 can recognize and can be used by location module 550 to lock onto for tracking purposes. In further embodiments, the setting information can include field of view data, resolution data, etc. The settings information can be communicated at an appropriate frequency rate, such as 60 Hz.

Immersive content server 540, which can be representative of immersive content server 140 shown in FIG. 1, can augment the experience of a participant using mobile device 520 by inserting computer-generated characters and objects into the virtual environment thus allowing the participant to experience characters, props and scenery that do not exist in the physical environment and are part of a script or storyline in which the participant partakes. In order to display the computer-generated characters or objects on the screen of the mobile device 520, they can first be inserted into the virtual environment, then rendered from the perspective of a virtual camera that matches the perspective of mobile device 520.

In some embodiments, immersive content server 540 can be one or more computer systems usable for managing, controlling, processing content for, and communicating with various parts of the location based immersive content system 500. The immersive content server 540 can also generate content and manage state information for a virtual world. In one embodiment, immersive content server 540 and presentation system 510 can communicate with one another over one or more suitable networks 505, such as a local intranet, cellular network (e.g., 4G, 5G, LTE) and/or the Internet.

In one embodiment, immersive content server 540 can include a rendering module 552, a location module 550, a calibration module 554, a color correction module 556, a 3D audio module 558, a synchronization module 560 and an analytics module. The immersive content server 540 can also access one or more databases 564 that store information used by the server in providing a model of the virtual environment. Towards this end, databases 564 can store content information (e.g., virtual characters, virtual items, virtual backgrounds, storylines, timeline information, etc.) and location data associated with the content information enabling the immersive content server to render views of the virtual world from any location and any perspective within the boundaries of the AR setting in which a mobile device 520 can be positioned. Databases 564 can also include location information (e.g., street maps, terrain maps, points of interest, building data, etc.) that can be used to more precisely locate a participant within the real world.

Location module 550 can provide information to rendering module 552 such that the rendering module can generate a view of the virtual content from a perspective that matches the view of the participant in the real world. Towards this end, location module can receive telemetry data from sensors 526 of mobile device 520 to precisely locate the participant in the physical world. For example, the immersive content server can receive GPS coordinates from the mobile device to determine the position of the user and use additional telemetry data (e.g., yaw, pitch and roll information) to determine a direction in which mobile device 520 is facing. In doing such, location module 550 can access one or more databases (e.g., database 564) such as a points of interest database, street maps, building data, terrain maps, etc. to determine the surroundings of a participant. In some embodiments, location module 550 is able to precisely locate a participant with centimeter accuracy using a multi-layered location approach where each layer of the location process adds different sources of data to more precisely pinpoint the participant's location within the physical world and the participant's orientation (i.e., the direction in which the mobile device is pointed) with respect to features in the physical world. As an example, in some embodiments location module 550 can determine an initial location of a participant in the physical world based on GPS coordinates that might be within a few meters of the participant's actual location. Location module can then perform additional layers of analysis, including street maps, image anchors, and visual positioning system (VPS) data that determines location based on imagery rather than GPS signals, to triangulate the participant's position down to centimeter or even millimeter accuracy.

In some embodiments, real world locations that virtual content resides in can be pre-scanned and data from the scan stored in database 564 and provided to animators that can register the virtual content to specific features within the location and orient the scene to the location. For example, if there is a staircase at the location, immersive content server 540 will know the exact location of the staircase and provide the virtual characters with location awareness so they can climb up or down the staircase if the storyline dictates such. Additionally, virtual characters can be given location awareness. Characters can be geolocated at a specific location and can be unique to that location. The virtual characters (or other virtual objects) can then interact with participants based on attributes AR server 540 assigns to the location. That is, server 540 can use location data to make decisions on how virtual content reacts to participants.

Once a location is determined, immersive content server 540 can also use a virtual environment database (e.g., content/location database 564) to determine whether any virtual objects are in proximity to the participant, and if so, where such virtual objects correspond to a physical world location. The immersive content server can also receive depth information about objects in the environment collected by depth sensors embedded in the mobile device (e.g., a Lidar sensor). Based on information regarding a user's location and the virtual objects corresponding to the location, the immersive content server can enable an immersive experience to be generated for the user to be displayed on the user's mobile device. For example, immersive content server 540 can determine which virtual objects occlude or are occluded by physical objects in the user's location. The immersive content server can also determine whether certain reflections of physical objects need to be projected onto virtual objects. The immersive content server can also determine whether certain reflections of virtual objects need to be overlayed on the physical environment as described below.

Rendering module 552 can render images from the virtual environment in a way that matches the view of a participant holding mobile device 520 based, in part, on the location and orientation information provided by location module 550. Rendering module can then position a virtual camera at the identified position, oriented in the same lines as the camera of mobile device 520 to render the virtual content. Rendering module 552 can render such content in real-time, substantial real-time or at interactive frame rates (e.g., 30, 60, 120, 240 frames per second) to be transmitted back to mobile device 520. In one aspect, rendering module 552 can receive input from mobile device 520 including information location and telemetry information from sensor module 526 (e.g., GPS information, motion information, Wi-Fi information, Bluetooth information, depth information, etc.). The rendering module 552 can generate images for an item of content to be displayed by mobile device 520 based on the sensor input, positional information, calibration information, visual information, and other information from the other modules. For example, the rendering module can generate, for display, an image based on a location of a tablet device as indicated by its GPS coordinates. The rendering module 552 can also use other collected information (e.g., analytics data) to generate the imagery for display over the mobile devices. In generating the virtual content, rendering module 552 can position a virtual camera in the virtual environment to correspond to the camera of mobile device 520 in the physical environment. The virtual camera can be located and oriented to match the location and orientation of the physical camera in the corresponding physical environment such that an image generated from the perspective of the virtual camera will generally match the field of view and perspective of an image captured by the physical camera.

In some embodiments, the rendering module can also generate images based on input or interactions provided by a user (i.e., a participant in the AR setting generated by location-based immersive system 500). For example, a participant can interact with a virtual object displayed over AR glasses by indicating to the app that the AR object should be moved. In response to the indication, rendering module 552 can render an image that shows the AR object being moved accordingly.

In some instances, immersive content server 540 can communicate image data, audio data and telemetry data to a mobile device. The image data can include red, green, blue, alpha (R,G,B,A) data, depth data, and/or shadow data. The image data can be communicated to the mobile device at a rate of 60 Hz or more. In some embodiments, six separate channels of image data are communicated to the mobile device by interleaving frames of three channels each (e.g., a first frame of RGB data followed by a second frame of alpha, depth, shadow data) or by rendering the image double height (e.g., splitting each frame into a top half for RGB data and a bottom half, aligned to the top half, of alpha, depth, shadow data). The telemetry data can include location information and orientation information (e.g., yaw, pitch, and roll data) corresponding to the generated imagery. In some instances, the telemetry data can also be communicated at 60 Hz. Such information can be used by rendering modules of the mobile devices to generate user perspective correct imagery for display over the mobile devices.

Immersive content system 500 can also include a calibration module 554. The calibration module receives calibration information for an environment in which a mobile device is used. The calibration information can include environment dimensions, object configurations, lighting conditions, obstruction information, sun positioning, and/or the like. The calibration information can be used by the rendering module to generate customized images to be displayed by the mobile device to a user. In this way, images provided to the user can be appropriately displayed for a given environment and location. For example, the rendering module can use the information to correctly display shadows based on the position of the sun at the mobile device's physical location.

In some embodiments, calibration module 554 can upload an environment sphere (environ sphere) from mobile device 520 to provide improved lighting information. The environ sphere can be an RGB image that provides information about the environment surrounding the mobile device (e.g., like a 360-degree photograph) providing information to calibration module 554 that is useful for lighting calculations. For example, the environ sphere can provide information about where in physical environment elements such as green grass, trees, building and/or blue sky that can impact bounced lighting are present. Information from the environ sphere can then be used such that when light is bounced in an image being rendered, the correct color of light is used. For example, the sky bounces blue light, the grass bounces green light. The environ sphere can be captured by the mobile device as part of background processing that is invisible to the user.

The immersive content system can also include a module 556 for accepting color correction, contrast, and other visual information (e.g., digital intermediates (“DI”) grades). Such information can be applied to the images to be displayed by the display module in order to make sure that the visual qualities of content displayed by the mobile device are consistent with the colors seen by the participant in the real world (e.g., the colors of virtual objects rendered by rendering module 550 can be adjusted based on the weather conditions in the real world that impact lighting in the vicinity of the participant) and that visual qualities of the content displayed over a movie screen. In some embodiments, the visual information can include an animated look-up table, color correction curves, RGB curves, luminance information, etc.

In yet another embodiment, the immersive content system can include a module 558 for receiving and generating 3D audio (spatialized audio) for an item of content. The 3D audio can be generated based on information received from sensors of the mobile device. For example, the 3D audio can be generated based on the current head position of a user of a pair of AR glasses.

In some embodiments, the mobile device can store pre-generated images of an item of content (e.g., pre-rendered frames). In this way, more complicated images can be presented to a user without having to be rendered in real-time by the rendering module (and expending substantial computer resources). The pre-generated content can be received from the immersive content server over a highspeed network (e.g., 5G, Wi-Fi, etc.) while content is being displayed to a user of the mobile device or preloaded onto the mobile device. In some embodiments, the pre-generated content can be composited with content rendered by a rendering module of the mobile device and/or images of the physical environment taken by the mobile device. The mobile device can also receive synchronization data from the immersive content server (or some other system). The mobile device can use the synchronization data to ensure that the images displayed by the display module are in sync with the environment.

In some embodiments, the immersive content server can operate and manage a persistent virtual environment. As such, multiple users can use their mobile devices to interact with the persistent virtual environment and the immersive content server will maintain the state of the virtual environment over time. For instance, a user's interactions with a virtual object can persist even if the user is no longer logged into and/or interacting with virtual environment. The state of the virtual object can be maintained and viewable by other users. In order to operate and maintain the persistent virtual environment, the immersive content server can store state information for one or more users, virtual objects, physical environments, storylines, and/or the like. The stored state information can include, for instance, location information (e.g., GPS coordinates) for users, mobile devices and virtual objects, virtual object attribute information (e.g., color, texture, etc.), virtual object state data (e.g., the state of a virtual character within an interactive storyline), mobile device attribute information (e.g., distortion attributes associated with lenses of a mobile device), etc.

In some embodiments, the virtual environment can be associated with a multi-user interactive storyline. The storyline can include several story branches. Each story branch can include different virtual characters, virtual character actions, virtual objects, virtual interaction opportunities, story text, and/or the like. In some embodiments, each story branch can be associated with certain times, weather/environmental conditions, and/or locations. For example, a particular story branch can be presented to one or more mobile devices at p.m. during a rainstorm in a grassy area of San Francisco. A virtual character of the story branch can say certain things and/or perform certain actions based on the location of the mobile device of the user. In some embodiments, the story branch can be accessed and/or viewed by one or more mobile devices connected to the immersive content server. In some embodiments, certain branches of the storyline can be presented based on previous interactions of the users with the virtual environment.

In some embodiments, the storyline can be procedurally and/or automatically generated based on a script received from a user. The script can include metadata to allow the immersive content server to automatically/procedurally generate virtual objects, place/associate the virtual objects with certain physical locations and times, etc. In some embodiments, the immersive content server can generate the storyline based on a trained machine learning model. For example, the immersive content server can place/associate virtual objects with certain physical locations based on the model.

In one embodiment, the immersive content server can include a synchronization module 560 for collecting and facilitating interactions between different users of the mobile devices. Such interactions can include simultaneous or near simultaneous interaction with virtual objects, games, text messages, information sharing, screen sharing, and/or the like. For example, a user of a first tablet device can view and interact with a virtual object with which another user of a second tablet device is also viewing and interacting. The information regarding the interactions can be sent to the immersive content server. The immersive content server can synchronize the interactions across the tablets so that the interactions are consistently displayed between the tablets. For example, a user of a tablet can “grab” a virtual object and place the virtual object in a virtual bag. In response, the immersive content server can signal to a second tablet to remove the object from display such that a user of the second tablet cannot “grab” the virtual object.

In one aspect, immersive content server 540 can also include an analytics module for processing analytical information received from the mobile devices. For example, the analytics module can obtain information regarding what objects users are looking at or how many users are interacting with an interactive portion of immersive content. Such information can be used to enhance a user's immersive experience. As another example, the analytics module can keep track of and provide information on how many (if any) of the mobile devices are crashing or experiencing problems. The information can also be used to procedurally generate virtual objects based on a determined popularity among users (e.g., more or less virtual objects can be generated based on a high or threshold user interaction rate).

Methods of Compositing Virtual Content with Real-World Images

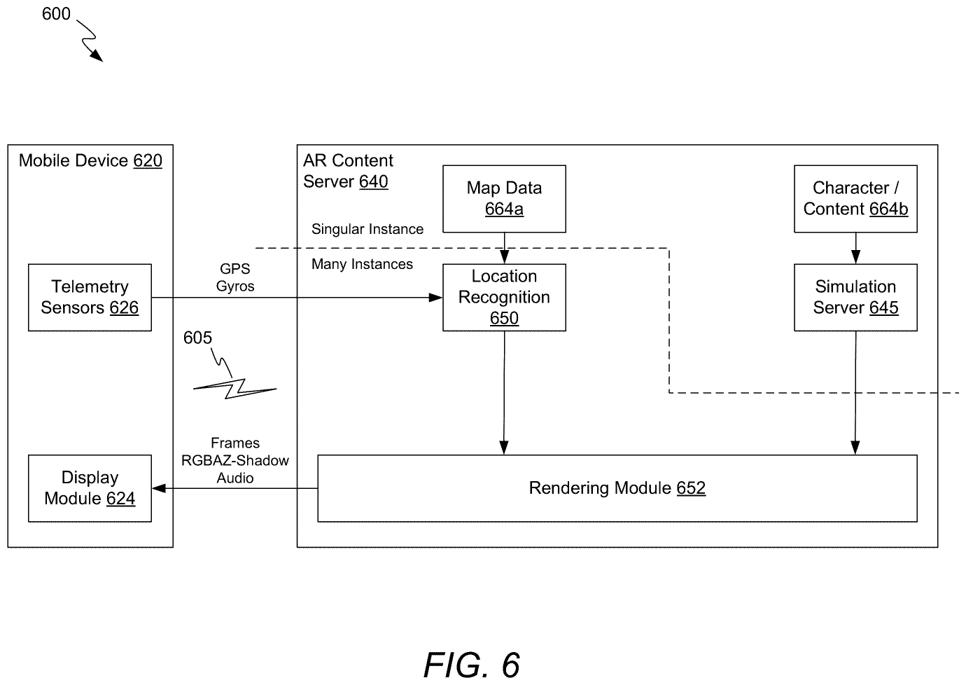

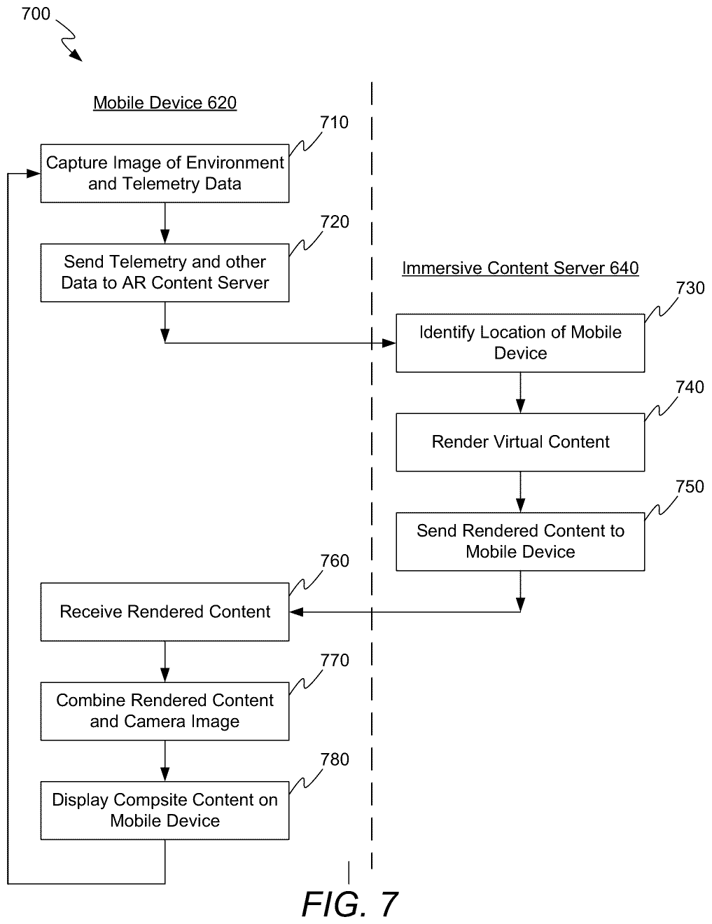

In order to further illustrate aspects of various embodiments disclosed herein, reference is made to FIGS. 6 and 7 in which FIG. 6 is a simplified block diagram of a system 600 that includes a single mobile device 620 interacting with a Immersive content server 640 and FIG. 7 is a flow chart depicting steps associated with a method in accordance with some embodiments. For descriptive purposes, various method steps depicted in FIG. 7 performed by mobile device 620 are shown in the left side of the flow chart while the various method steps performed by immersive content server 640 are shown on the right side of the flow chart.

Mobile device 620 can be representative of a mobile device 520 shown in FIG. 5 and immersive content server 640 can be representative of immersive content server 540. Communication between mobile device 620 and immersive content server 640 can occur over a wireless network 605, which can be similar to wireless network 505 discussed above.

As discussed above, mobile device 620 can be used by a participant to explore a virtual world created by immersive content server 640 which populates a real-world environment with virtual characters and/or items (sometimes collectively referred to herein as “virtual objects”). Mobile device 620 can be worn or held by a participant to view the virtual objects when an appropriate app (not shown in FIG. 6) is installed and executing on the mobile device. As the participant then walks around or otherwise traverses through or explores the physical environment in which immersive content server 640 populates virtual objects, based on the location of the participant and the location at which various virtual objects are geolocated, system 600 can superimpose virtual objects over and within the actual, physical-world scenery on a display of the mobile device.

In doing such, mobile device is continuously capturing images of the physical world and collecting telemetry data with sensors 626 (e.g., GPS position, yaw, pitch and roll data as discussed above) corresponding to the captured images (FIG. 7, step 710) and sending the collected telemetry data to immersive content server 640 (FIG. 7, step 720). In some embodiments, mobile device 620 sends telemetry data to immersive content server 640 at a set frequency rate of, for example, 60 Hz.

In addition to the telemetry data, mobile device 620 can also periodically send camera settings data representing physical settings of the mobile device camera to immersive content server 640 as well as an RGB environ sphere image and data representing anchors that are identified at the location. The camera settings data can include the field of view (FOV) and resolution of the camera capturing the real-world environment in which the mobile device is located along with the focal length and f-stop used to take such images and other relevant camera setting data. Some of the settings data, such as FOV, can be sent at the rate as the telemetry data (e.g., 60 Hz) since it can change frequently with the focus of the camera. Other settings data, such as focal length and f-stop, can be updated only when the changes are made to those values. The anchors are objects that can be recognized by immersive content server 640 and used by the server to integrate virtual content into the real world. In some embodiments, anchors can be determined automatically by a software developer kit, such as the ARKit available for Apple iOS devices or the ARCore available for android devices.

As discussed above, the RGB environ sphere image provides information to immersive content server 640 about the general environment in which the mobile device is located and can be used by server 640 to adjust lighting of rendered virtual content. The environ sphere can be sent (or updated after being initially sent) whenever mobile device 620 determines that sufficient changes in the environ sphere have taken place to warrant an update. In general, updates to the environ sphere image can occur bursts, rather than at a regular frequency, and might occur, for example, every several seconds to every several minutes (e.g., between 5 seconds and 5 minutes).

Data for image anchors can similarly be updated in bursts when changes to the accuracy of any image anchors that are visible at the location are detected. In some embodiments, both environ sphere and anchor updates can be done in the background automatically by a software developer kit or similar feature of mobile device 620, such as the ARKit available for Apple IOS devices or the ARCore available for android devices. Additionally, in some embodiments, the image anchors can be automatically identified and monitored in the background by the software developer kit or a similar function within the immersive content application executing on mobile device 620 (e.g., app 528).

AR server 640 receives the telemetry data and other data and identifies where in the real world the participant is located (FIG. 7, step 730). In identifying the participant's location, location recognition module 650 can determine an initial location of the participant based on GPS coordinates. The location recognition module can then access map and location data from one or more databases 664a, such as street maps, visual positioning system (VPS) data, image anchors, and other information, to triangulate the participant's position down to centimeter or even millimeter accuracy.

Once a location is determined, a simulation server 645 can identify whether any virtual characters or virtual objects are present at the participant's location and provide that information to rendering module 652. The rendering module can then use the location, telemetry data, environ sphere, and information from simulation server 645 to render content that is perspective correct and lit properly and that implements what the story/script dictates (FIG. 7, step 740). For example, when a participant enters location X, the story can dictate that a virtual character walks up to the participant, talks to the participant and then performs one or more actions, such as digitally scanning the participant as part of the story line. In some implementations, rendering module 652 can also use camera and display setting data representing physical attributes of the mobile device, such as the field of view of the camera lens, the lens focal length and f-stop used to capture an image, lens distortion and resolution of the display when rendering images so that the rendered content properly fits within the scene composited on the mobile device display. Thus, for example, step 740 can render the virtual content at a resolution determined by the display (i.e., screen width in pixels) of the mobile device.

In rendering the virtual content, rendering module 652 can position a virtual camera within the virtual world at the location of the camera of mobile device 520 and oriented in the same manner as the mobile device camera. Rendering module 652 can render such content in real-time at interactive frame rates. In some instances, the location and orientation of mobile device 620 might not change between frames captured by the camera and the virtual content may not change as well. In such instances, in order to save processing demands on server 640, the server can determine at each frame whether an update to the rendered virtual content is required before going through the processing steps needed to update the virtual environment. Some embodiments may require changes in the orientation of mobile device 621 to exceed a predetermined threshold (e.g., a change in the field of view by more than 0.5% or 1% or more than 0.5 cm or 1 cm) in order to determine that the rendered virtual content should be updated.

The rendered content can then be wirelessly transmitted to mobile device 620 along with any audio data associated with the content (FIG. 7, step 750) and received by display module 624 (FIG. 7, step 760). In some embodiments the rendered content is sent to mobile device at a set frequency, such as 60 Hz or the same frequency at which the mobile device transmits telemetry data do immersive content server 640. In some embodiments, the rendered content includes six separate channels of information, RGBA channels (red, green, blue and alpha) along with separate channels for depth and shadow information. The alpha parameter can be a number between 0.0 (fully transparent) and 1.0 (not transparent at all). The depth parameter can indicate a distance of content be rendered from the mobile device which the rendering module 652 and/or display module 624 can use to depth sort the render (i.e., position an object from the real world in between, depth wise, two different virtual characters or other virtual content). The shadow parameter allows the rendered scene to be lit properly when composited. In some embodiments, the six separate channels of image data are sent to the mobile device in step 760 by rendering the image double height (e.g., splitting each frame into a top half for RGB data and a bottom half, aligned to the top half, of alpha, depth, shadow data).

When mobile device 620 receives the rendered image from server 640, the mobile device can composite together the rendered image with a view of the real world on the display of the device (FIG. 7, step 770). The camera image from the mobile device can be considered a background image and the rendered image from immersive content server 640 can be superimposed over the camera image as a foreground image. In this manner, the virtual content from the virtual environment that is in the field of view of the participant, is displayed on the mobile device display (FIG. 7, step 780). Some portions of the rendered image can be hidden or partially behind objects of the background camera image through the depth channel and other portions of the rendered image can be made transparent or partially transparent through the alpha channel data. Additionally, shadows can be projected onto portions of the composite image based on the shadow channel data. In this manner, the six channels of data allow for complex special effects, such as smoke, fog or mist to be part of the virtual content that is rendered and composited in a realistic manner at a correct distance from the participant on the mobile device display.

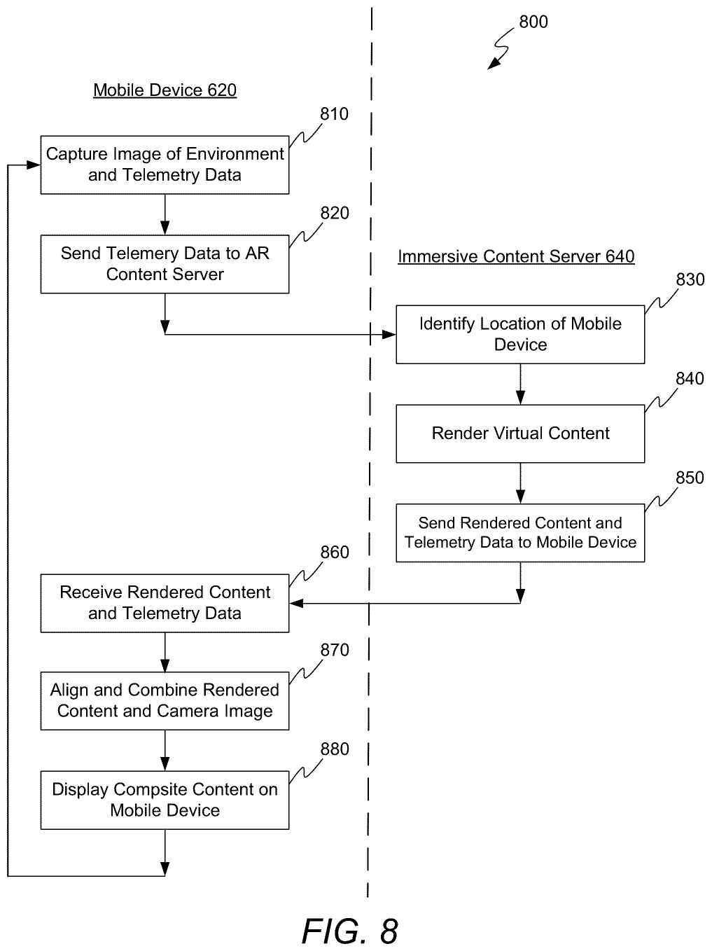

Method 700 can be executing and repeating in real time such that the rendered content is constantly being updated and composited with new camera images that are continuously displayed on mobile device 620 as an uninterrupted video feed. While embodiments disclosed herein can include very high speed computing devices with high speed graphics processors along with very high speed wireless communication links to transmit data between mobile device 620 and immersive content server 640, some embodiments take additional measures to prevent or reduce potential latency differences between the rendered virtual content and the background image of the real-world environment that the virtual content is composited with. FIG. 8 is a flow chart depicting steps associated with a method 800 that reduces such latency differences in accordance with some embodiments.

As depicted in FIG. 8, method 800 includes a number of steps that are substantially similar to those discussed above with respect to method 700. Thus, for ease of description, the discussion below will focus primarily on differences between the two methods and the steps that are generally similar to each other have reference numbers that differ from each other only in whether the reference numbers start with a “7” or an “8”. Thus, step 810 in method 800 can be generally similar to step 710 in method 700, step 820 in method 800 can be similar to set 720 in method 700, etc. with key differences between the generally similar steps discussed below.

As depicted in FIG. 8, mobile device 620 is continuously capturing images of the physical world and continuously collecting telemetry data from sensors 626 (e.g., the telemetry data discussed above with respect to FIG. 7) corresponding to the captured images (FIG. 8, step 810). Method 800 also continuously sends the captured telemetry data to immersive content server 640 (FIG. 8, step 820). In some embodiments, telemetry data is sent to immersive content server 640 in step 820 at a set frequency rate of, for example, 60 Hz, which means data is sent every 16.67 msec.

At each instance when telemetry data is uploaded to server 640, the server can identify a location of the mobile device based on the telemetry data and other data (FIG. 8, step 830) as discussed above with respect to step 830. After a location is determined and simulation server 645 identifies whether any virtual content should be generated based on the participant's location in the real world, rendering module 652 can then use the location, telemetry data, environ sphere, and information from simulation server 645 to render content that is perspective correct and lit properly and that implements what the story/script dictates (FIG. 8, step 840).

The content rendered in step 840 can differ in size from (i.e., can be larger than or over rendered compared to) the content rendered by method 700 in step 740 as discussed. Additionally, method 800 sends both the rendered virtual content and telemetry data used to generate the rendered content (referred to below as a “first set” of telemetry data) back to mobile device 620 (FIG. 8, step 850) instead of just the rendered content as done in method 700.

As shown in FIG. 8, mobile device 620 receives both the rendered virtual content and the first set of telemetry data (step 860) and composites the rendered content with an image of the physical environment real-world (step 870) for display on the mobile device (step 880).

In the brief amount of time between when the first set of telemetry data was captured (i.e., the set of telemetry data used to render the virtual content) and the time at which mobile device 620 receives and composites the rendered virtual content with its camera image, the position and/or orientation of mobile device 620 may have changed slightly such that the image of the real-world shown on the display of mobile device 620 may have shifted slightly from the image for which the first set of telemetry data corresponds. As an example, if mobile device 620 is capturing images of the real world at a rate of 60 frames per second (i.e., capturing a new frame every 16.67 msec) and it about 50 msec for rendered content generated from a set of telemetry data to be generated and sent back to the mobile device (i.e., 50 msec latency period, the time it takes for steps 820-860 to be completed), the display of the mobile device might depict an environment taken three frames after the frame for which the first set of telemetry data corresponds and can depict the physical environment from a slightly different perspective or angle than the perspective and angle that the rendered content was generated for.

Method 800 can adjust the rendered virtual image to account for this difference so that the rendered virtual image “sticks to” (i.e., is positioned more correctly within) the background camera image more accurately. In doing such, telemetry data (referred to below as a “second set” of telemetry data) captured by method 800 at a point in time closer to the point in time at which the mobile device received the rendered content (i.e. captured at a time closer to when the composited image will be displayed and thus represents a more accurate location and orientation of mobile device 620 at a point in time closer to when the rendered virtual image and camera image will be composited together) can be used in compositing the image. In the example where the latency time is 50 msec, step 870 can continuously be compositing rendered virtual content with background images from the camera of mobile device 620 that were taken three frames after the telemetry data for the rendered content was captured.

The rendered virtual image can then be reprojected based on differences identified between the first and second sets of telemetry data (FIG. 8, step 870). The difference between the two sets of telemetry data represents movement of the mobile device camera from the location at which the virtual content was rendered for and the current location of the camera. Thus, the field of view of the camera may have changed based on the movement and there might be some portion of the current field of view of the camera that is outside the field of view of the camera as represented by the first set of telemetry data. To account for this, method 800 can render an area that is larger than the field of view of camera (in FIG. 8, step 840) as determined based on the first set of telemetry data area. In various embodiments, the rendered area can be 5% larger than the field of view, 10% larger than the field of view or 25% larger than the field of view. Thus, the rendered virtual image can be larger than images generated by the video feed (the current camera images) so that the rendered virtual image can be composited or reprojected onto the current video feed properly (FIG. 8, step 870). Once so composited, the composited image can be displayed on the mobile device display (FIG. 8, step 780) and the process can continuously repeat itself.

### Special-Purpose Computer System

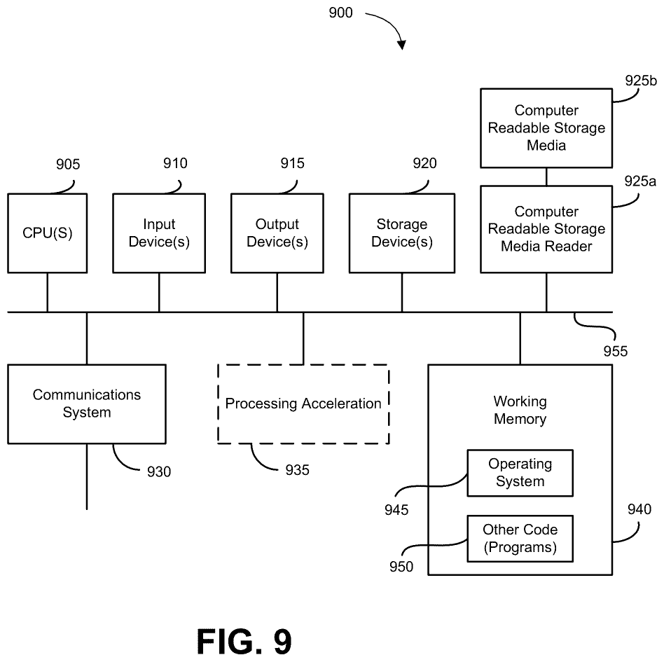

Each of the embodiments disclosed herein can be implemented in a special-purpose computer system. FIG. 9 illustrates an exemplary computer system 900, in which parts of various embodiments of the present invention can be implemented. The system 900 can be used to implement any of the computer systems described above. The computer system 900 is shown comprising hardware elements that can be electrically coupled via a bus 955. The hardware elements can include one or more central processing units (CPUs) 905, one or more input devices 910 (e.g., a mouse, a keyboard, etc.), and one or more output devices 915 (e.g., a display device, a printer, etc.). The computer system 900 can also include one or more storage device 920. By way of example, storage device(s) 920 can be disk drives, optical storage devices, solid-state storage device such as a random-access memory (“RAM”) and/or a read-only memory (“ROM”), which can be programmable, flash-updateable and/or the like.

The computer system 900 can additionally include a computer-readable storage media reader 925a, a communications system 930 (e.g., a modem, a network card (wireless or wired), an infra-red communication device, etc.), and working memory 940, which can include RAM and ROM devices as described above. In some embodiments, the computer system 900 can also include a processing acceleration unit 935, which can include a DSP, a special-purpose processor and/or the like.

The computer-readable storage media reader 925a can further be connected to a computer-readable storage medium 925b, together (and, optionally, in combination with storage device(s) 920) comprehensively representing remote, local, fixed, and/or removable storage devices plus storage media for temporarily and/or more permanently containing computer-readable information. The communications system 930 can permit data to be exchanged with the network 920 and/or any other computer described above with respect to the system 900.

The computer system 900 can also comprise software elements, shown as being currently located within a working memory 940, including an operating system 945 and/or other code 950, such as an application program (which can be a client application, web browser, mid-tier application, RDBMS, etc.). It should be appreciated that alternate embodiments of a computer system 900 can have numerous variations from that described above. For example, customized hardware might also be used and/or particular elements might be implemented in hardware, software (including portable software, such as applets), or both. Further, connection to other computing devices such as network input/output devices can be employed. Software of computer system 900 can include code 950 for implementing embodiments of the present invention as described herein.

Each of the methods described herein can be implemented by a computer system, such as computer system 900 in FIG. 9. Each step of these methods can be executed automatically by the computer system, and/or can be provided with inputs/outputs involving a user. For example, a user can provide inputs for each step in a method, and each of these inputs can be in response to a specific output requesting such an input, wherein the output is generated by the computer system. Each input can be received in response to a corresponding requesting output. Furthermore, inputs can be received from a user, from another computer system as a data stream, retrieved from a memory location, retrieved over a network, requested from a web service, and/or the like. Likewise, outputs can be provided to a user, to another computer system as a data stream, saved in a memory location, sent over a network, provided to a web service, and/or the like. In short, each step of the methods described herein can be performed by a computer system, and can involve any number of inputs, outputs, and/or requests to and from the computer system which can or cannot involve a user. Those steps not involving a user can be said to be performed by the computed without human intervention. Therefore, it will be understood in light of this disclosure, that each step and each method described herein can be altered to include an input and output to and from a user or can be done automatically by a computer system. Furthermore, some embodiments of each of the methods described herein can be implemented as a set of instructions stored on a tangible, non-transitory storage medium to form a tangible software product.

### Additional Embodiments

In the foregoing description, for the purposes of illustration, methods were described in a particular order. It should be appreciated that in alternate embodiments, the methods can be performed in a different order than that described. It should also be appreciated that the methods described above can be performed by hardware components or can be embodied in sequences of machine-executable instructions, which can be used to cause a machine, such as a general-purpose or special-purpose processor or logic circuits programmed with the instructions to perform the methods. These machine-executable instructions can be stored on one or more machine readable mediums, such as CD-ROMs or other type of optical disks, floppy diskettes, ROMs, RAMS, EPROMS, EEPROMs, magnetic or optical cards, flash memory, or other types of machine-readable mediums suitable for storing electronic instructions. Alternatively, the methods can be performed by a combination of hardware and software.

In the foregoing specification, aspects of the invention are described with reference to specific embodiments thereof, but those skilled in the art will recognize that the invention is not limited thereto. For example, while rendering module 570 was discussed above as part of the immersive content server 540, in some embodiments the functionality of the rendering module can be implemented on mobile device 520 or across a combination of mobile device 520 and immersive content server 540. Various features and aspects of the above-described invention can be used individually or jointly. Further, embodiments can be utilized in any number of environments and applications beyond those described herein without departing from the broader spirit and scope of the specification. The specification and drawings are, accordingly, to be regarded as illustrative rather than restrictive.

Additionally, for the purposes of explanation, numerous specific details have been set forth in order to provide a thorough understanding of various embodiments of the present invention. It will be apparent, however, to one skilled in the art that embodiments of the present invention can be practiced without some of these specific details. In other instances, well-known structures and devices can have been shown in block diagram form.

This description has provided exemplary embodiments only, and is not intended to limit the scope, applicability, or configuration of the disclosure. Rather, this description of the exemplary embodiments provides those skilled in the art with an enabling description for implementing an exemplary embodiment. It should be understood that various changes can be made in the function and arrangement of elements without departing from the spirit and scope of the invention as set forth in the appended claims.

Specific details have been given in the description to provide a thorough understanding of the embodiments. However, it will be understood by one of ordinary skill in the art that the embodiments can be practiced without these specific details. For example, circuits, systems, networks, processes, and other components can be shown as components in block diagram form in order not to obscure the embodiments in unnecessary detail. In other instances, well-known circuits, processes, algorithms, structures, and techniques can be shown without unnecessary detail in order to avoid obscuring the embodiments.

Also, it is noted that individual embodiments can be described as a process which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed, but could have additional steps not included in a figure. A process can correspond to a method, a function, a procedure, a subroutine, a subprogram, etc. When a process corresponds to a function, its termination can correspond to a return of the function to the calling function or the main function.

The term “non-transitory, computer-readable medium” includes, but is not limited to portable or fixed storage devices, optical storage devices, and various other mediums capable of storing instruction(s) and/or data. A code segment or machine-executable instructions can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc., can be passed, forwarded, or transmitted via any suitable means including memory sharing, message passing, token passing, network transmission, etc.

Furthermore, embodiments can be implemented by hardware, software, firmware, middleware, microcode, hardware description languages, or any combination thereof. When implemented in software, firmware, middleware or microcode, the program code or code segments to perform the necessary tasks can be stored in a machine readable medium. A processor(s) can perform the necessary tasks.

Additionally, for the purposes of illustration, methods can have been described in a particular order. It should be appreciated that in alternate embodiments, the methods can be performed in a different order than that described. It should also be appreciated that the methods described above can be performed by hardware components or can be embodied in sequences of machine-executable instructions, which can be used to cause a machine, such as a general-purpose or special-purpose processor or logic circuits programmed with the instructions to perform the methods. These machine-executable instructions can be stored on one or more machine readable mediums, such as CD-ROMs or other type of optical disks, floppy diskettes, ROMs, RAMS, EPROMs, EEPROMs, magnetic or optical cards, flash memory, or other types of machine-readable mediums suitable for storing electronic instructions. Alternatively, the methods can be performed by a combination of hardware and software.

What is claimed is:

1. A computer-implemented method comprising:
capturing, with a mobile device comprising a camera and a display, a first image of a physical environment along with location data and orientation data corresponding to the first image;
transmitting, to a server system via a wireless communication channel, the location and orientation data;
determining, with the server system, a precise location and orientation of the mobile device in the physical environment based on the location and orientation data received from the mobile device and on information accessed from multiple sources of data including one or more of a street map database, visual positioning system (VPS) data, and image anchors;
rendering, with the server system, an image of virtual content based on the precise location of the mobile device determined by the server system;
transmitting the rendered image back to the mobile device via the wireless communication channel;
compositing, at the mobile device, the rendered image with an image of the physical environment captured by the mobile device; and
displaying the composited image on the display of the mobile device such that the virtual content appears in the physical environment.

2. The computer-implemented method set forth in claim 1 wherein the orientation data comprises roll, yaw and pitch data.

3. The computer-implemented method set forth in claim 1 wherein the rendered image sent by the server system comprises six channels of information including separate channels for red, green, blue, alpha, depth and shadow data.

4. The computer-implemented method set forth in claim 3 wherein the six channels of information are each sent every frame by splitting each frame into top and bottom portions and sending the RGB data in one of the top and bottom portions and sending the alpha, shadow and depth data in the other of the top and bottom portions.

5. The computer-implemented method set forth in claim 3 wherein the six channels of information are each sent every other frame by repeatedly sending a first frame with the RGB data and, immediately following the first frame, sending a second frame with the alpha, shadow and depth data.

6. The computer-implemented method set forth in claim 1 wherein the telemetry data is sent by the mobile device to the server at a first frequency of between 30-120 Hz and the mobile device also sends camera settings data including data representing the field of view (FOV) and resolution of the camera and data indicating the focal length and f-stop of the lens that the first image was captured at.

7. A computer-implemented method comprising:
capturing, with a mobile device comprising a camera and a display, a first image of a physical environment and first set of telemetry data corresponding with the first image, wherein the first set of telemetry data comprises GPS location data along with orientation data;
transmitting, to a server system via a wireless communication channel, the first set of telemetry data;
determining, with the server system, a precise location and orientation of the mobile device in the physical environment based on the first set of telemetry data received from the mobile device and on information accessed from multiple sources of data including one or more of a street map database, visual positioning system (VPS) data, and image anchors;
rendering an image of virtual content based at least in part on the first set of telemetry data for the mobile device, wherein the rendered image of virtual content is over rendered such that it represents a larger area in the virtual world than the first image represents in the physical environment;
transmitting the rendered image and the first set of telemetry data back to the mobile device via the wireless communication channel;
capturing, with the mobile device, a second image and a second set of telemetry data, wherein the second set of telemetry data comprises gps location data along with orientation data;
compositing, at the mobile device, a subset of the rendered image with the second image, wherein the subset of the rendered image is determined based changes between the first and second sets of telemetry data; and
displaying the composited image on the display of the mobile device such that the virtual content appears in the physical environment.

8. The computer-implemented method set forth in claim 7 wherein the orientation data comprises roll, yaw and pitch data.

9. The computer-implemented method set forth in claim 7 wherein the rendered image sent by the server system comprises six channels of information including separate channels for red, green, blue, alpha, depth and shadow data.

10. The computer-implemented method set forth in claim 9 wherein the six channels of information are each sent every frame by splitting each frame into top and bottom portions and sending the RGB data in one of the top and bottom portions and sending the alpha, shadow and depth data in the other of the top and bottom portions.

11. The computer-implemented method set forth in claim 9 wherein the six channels of information are each sent every other frame by repeatedly sending a first frame with the RGB data and, immediately following the first frame, sending a second frame with the alpha, shadow and depth data.

12. The computer-implemented method set forth in claim 7 wherein the telemetry data is sent by the mobile device to the server at a first frequency of between 30-120 Hz and the mobile device also sends camera settings data including data representing the field of view (FOV) and resolution of the camera and data indicating the focal length and f-stop of the lens that the first image was captured at.

13. The computer-implemented method set forth in claim 7 wherein the mobile device also sends an environ sphere comprising an RGB image to the server system via the wireless communication channel.

14. A computer-implemented method comprising:
capturing a first image of a physical environment and first set of telemetry data corresponding with the first image, wherein the first set of telemetry data comprises gps location data and orientation data;
transmitting the first set of telemetry data to a server system via a wireless communication channel;
receiving a rendered image of virtual content from the server system via the wireless communication channel, wherein the rendered image is generated based at least in part on the first set of telemetry data and wherein the rendered image of virtual content is over rendered such that it represents a larger area in the virtual world than the first image represents in the physical environment;
capturing a second image of a physical environment and second set of telemetry data corresponding with the second image, wherein the second set of telemetry data comprises gps location data and orientation data;
compositing, at the mobile device, a subset of the rendered image with the second image, wherein the subset of the rendered image is determined based changes between the first and second sets of telemetry data; and
displaying the composited image on the display of the mobile device such that the virtual content appears in the physical environment.

15. The computer-implemented method set forth in claim 14 wherein the orientation data comprises roll, yaw and pitch data.

16. The computer-implemented method set forth in claim 14 wherein the rendered image sent by the server system comprises six channels of information including separate channels for red, green, blue, alpha, depth and shadow data.

17. The computer-implemented method set forth in claim 16 wherein the six channels of information are each sent every frame by splitting each frame into top and bottom portions and sending the RGB data in one of the top and bottom portions and sending the alpha, shadow and depth data in the other of the top and bottom portions.

18. The computer-implemented method set forth in claim 16 wherein the six channels of information are each sent every other frame by repeatedly sending a first frame with the RGB data and, immediately following the first frame, sending a second frame with the alpha, shadow and depth data.

19. A computer-implemented method comprising:
receiving, from a mobile device comprising a camera and a display, a first set of telemetry data corresponding with a first image, wherein the first set of telemetry data comprises GPS location data along with orientation data;
determining a precise location and orientation of the mobile device in the physical environment based on the first set of telemetry data received from the mobile device and on information accessed from multiple sources of data including one or more of a street map database, visual positioning system (VPS) data, and image anchors;
rendering an image of virtual content based at least in part on the first set of telemetry data for the mobile device, wherein the rendered image of virtual content is over rendered such that it represents a larger area in the virtual world than the first image represents in the physical environment; and
transmitting the rendered image and the first set of telemetry data back to the mobile device via the wireless communication channel.

20. The computer-implemented method set forth in claim 19 wherein the orientation data comprises roll, yaw and pitch data.
